(19) United States
(12) Patent Application Publication
(10) Pub. No.: US 2023/0125128 A1
(43) Pub. Date: Apr. 27, 2023

(54) SHELF-STABLE SUPPLEMENT AND METHODS OF MAKING THEREOF

(71) Applicant: REVZR Tech Strategies, LP, Claymont, DE (US)

(72) Inventor: Nihad HAJDARHODZIC, Langhorne, PA (US)

(21) Appl. No.: 18/048,058

(22) Filed: Oct. 20, 2022

Related U.S. Application Data
(60) Provisional application No. 63/270,971, filed on Oct. 22, 2021.

(51) Int. Cl. A23L 33/135; A23L 33/125; A23L 33/00; A23L 29/231; A23L 29/256; A23P 30/10

(52) U.S. Cl. CPC A23L 33/135; A23L 33/125; A23L 33/40; A23L 29/231; A23L 29/256; A23P 30/10

(57) ABSTRACT

Disclosed herein is a supplement comprising a probiotic, one or more gelling agents, and a sweetener and methods for manufacture thereof, wherein the sweetener is a low glycemic index sweetener that provides a sugar content that permits the probiotic to live and thrive within the supplement without dramatically increasing blood sugar level upon consumption of supplement. The presence of a living and thriving probiotic culture within the supplement further contributes to extended shelf stability and overall lifetime of the supplement.

### CROSS-REFERENCE TO RELATED APPLICATIONS

This application claims priority to U.S. Provisional Patent Application No. 63/270,971, filed Oct. 22, 2021, the entirety of which is incorporated by reference herein.

### FIELD

The present technology relates generally to the field of food products, including probiotic compositions. In particular, the present technology relates to producing chewable food supplements, such as gummy, jelly, or other chewy products containing a living and thriving probiotic culture that has an extended shelf-life.

### SUMMARY

The present disclosure is drawn to a supplement, and more particularly a gummy composition that provides a source of probiotics while also having a pleasant taste and texture and being visually appealing. In particular, the disclosure provides an alternative to other probiotic supplements such as beverages, powdered supplements, and pills in that the probiotic of the present supplement has an extended shelf life and stability due to the supplement having a living probiotic culture, which thrives on a sugar level provided by a sweetener, which may have a low glycemic index. The present disclosure is therefore broadly directed to a probiotic supplement, such as gummy bites or pieces comprising a high level of probiotics that have an extended shelf life and stability due to the presence of a living probiotic culture within the supplement that does not drastically affect blood sugar levels upon consumption due to use of a low glycemic index sweetener.

In one aspect, a supplement comprises:
a probiotic;
one or more gelling agents;
a sweetener; and
optionally one or more flavoring agents.

In another aspect, the disclosure provides a supplement comprising a living probiotic culture, which contributes to an extended shelf life rendering the supplement amenable to long term storage.

In one embodiment, the probiotic is kombucha having a flavoring of a fruit having from about 1 to about 3% by weight of pectin, wherein the one or more gelling agents comprises the pectin of the fruit flavoring and about 1% by weight of agar-agar.

In some embodiments, the sweetener is blue weber agave syrup, which has a lower glycemic index than other sweeteners such as sugar, honey, and high fructose corn syrup, which provides a sugar content on which the living probiotic can live and thrive within the supplement, thus improving the shelf life and stability of the supplement without drastically increasing blood sugar levels upon consumption.

Further disclosed herein is a method of producing a supplement, which can include procuring a bulk volume of raw probiotic, reserving a volume of the bulk volume of raw probiotic for reintroduction and revival of the probiotic culture, concentrating the bulk volume of raw probiotic to a concentrated volume, reintroducing the reserved volume of raw probiotic to the concentrated volume to revive the probiotic and to achieve a final volume of probiotic, adding sweetener and one or more gelling agents to the final volume of probiotic to create a mixture, mixing and agitating the mixture, pouring the mixture into a mold, and curing the mixture to obtain the supplement.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited.

These and other embodiments are disclosed or are obvious from and encompassed by, the following Detailed Description.

### BRIEF DESCRIPTION OF THE DRAWINGS

The following detailed description, given by way of example, but not intended to limit the invention solely to the specific embodiments described, may best be understood in conjunction with the accompanying drawings.

FIG. 1 is a flowchart that outlines the steps of the method of manufacturing the supplement.

### DETAILED DESCRIPTION

The supplement described herein provides the benefits of probiotics packaged as a gummy medium, which contains a living probiotic culture within the supplement. The living probiotic culture contributes to an improved shelf life and stability rendering the supplement more amenable to long term storage.

The current disclosure describes embodiments of a supplement that provide a sugar content that is amenable to support a living probiotic culture, which contributes to the improved shelf life and stability of the supplement without drastically increasing blood sugar level upon consumption because the supplement utilizes a sweetener having a low glycemic index. Thus, the present supplement represents an alternative solution to those consumers seeking probiotic supplements who may suffer from a condition such as diabetes and would experience difficulty in managing an elevated blood sugar level.

The current disclosure also describes methods for manufacture of the supplement, which includes concentrating raw probiotic at an elevated temperature that inevitably kills the probiotic culture, but intensifies the flavor and permits gelation to occur. Prior to gelation, the method includes reintroduction of a volume of reserved raw probiotic, which serves to revive the probiotic culture such that the probiotic culture is living and thriving during storage of the supplement, which ultimately extends the longevity and shelf life of the supplement.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Any discussion of numerical values or ranges such as weight percentages and pH values can be understood as referring to the exact values and also reasonable approximations of those values/ranges as would be understood to a person of ordinary skill in the art.

The Food and Agriculture Organization (FAO) of the United Nations and the World Health Organization (WHO) define probiotic microorganisms as “live microorganisms which when administered in adequate amounts confer a health benefit for the host”. Products containing at least 10⁶-10⁷ cfu/gram are considered to provide a health benefit. (FAO/WHO, 2001). The term “probiotic” as used herein can mean one or more live microorganisms (e.g., bacteria or yeast) which, when administered appropriately, can confer a health benefit on the subject.

It is well-documented clinically that many species of bacterial, mycotic and yeast pathogens possess the ability to cause a variety of gastrointestinal disorders including, but not limited to: disruption of normal gastrointestinal biochemical function, necrosis of gastrointestinal tissues, and disruption of the bioabsorption of nutrients, and like conditions. The probiotic microorganism-containing supplements described herein inhibit these pathogens. Thus, the compositions are useful in the prophylactic or therapeutic treatment of conditions associated with infection by these aforementioned pathogens. The probiotic supplements disclosed herein are also used in the methods described herein for boosting the immune system.

Probiotics include any microorganism that has been determined to have a beneficial effect on the host and may include strains that have not yet been identified as having a beneficial host effect.

The supplement thereof may include probiotic microorganisms from one or more strains, species, or genera.

Bacteria such as lactic acid bacteria and bifidobacteria are known to be useful as probiotics but other microorganisms such as certain types of yeasts may also be useful in the present methods.

Kombucha is the name for a fermented tea that has been popular in many cultures throughout the eastern hemisphere for thousands of years. These cultures claim a significant health benefit to be gained by drinking kombucha, namely due to the high nutritional content and probiotic activity of the beverage. The name of the beverage in many cultures translates into “tea fungus” or “tea mushroom” due to the growth of a gelatinous biofilm (also known as a pellicle) at the liquid-gas interface. The biofilm is not a mushroom, but instead is what is known as a SCOBY, or a Symbiotic Colony of Bacteria and Yeast. While the microbial makeup of the SCOBY varies depending on the source of the culture, some of the more persistent organisms contained within kombucha include Saccharomyces and Gluconacetobacter xylinus.

The kombucha bacterial culture is a symbiotic colony comprising at least Gluconacetobacter xylinus. Other microorganisms contained in the culture may include, but are not limited to any yeasts, including Saccharomyces cerevisiae, Brettanomyces bruxellensis, Candida stellata, Schizosaccharomyces pombe, and Zygosaccharomyces bailii and any other microorganism derived from the genera Acetobacter, Azotobacter, Bacillus coagulans, Rhizobium, Agrobacterium, Pseudomonas, Gluconacetobacter, Alcaligenes, Lactobacillus, Lactococcus, Leuconostoc, Bifidobacterium, Thermus, Allobaculum, Ruminococcaceae, Incertae Sedis, Enterococcus, Salmonella, Sarcina, and Propionibacterium.

In one embodiment, the probiotic is a lactic acid bacteria. In another embodiment, the probiotic is a yeast. In another embodiment, the probiotic is preferably in the form of kombucha.

In some embodiments, the kombucha comprises Bacillus coagulans, which is a gram-positive rod-shaped bacterium, is catalase positive, is spore-forming, is motile, and is a facultative anaerobe. B. coagulans has been shown to be effective in improving gastrointestinal function, for example, in terms of the treatment of acute diarrhea. See R. Sudha et al. Efficacy of Bacillus Coagulans Strain Unique IS-2 in the treatment of Patients with Acute Diarrhea. International Journal of Probiotics & Prebiotics, February 2012, Vol. 7 Issue 1 p33-37. B. coagulans has been shown to be effective in treating vaginosis. R. Sudha et al. Clinical study of Bacillus coagulans Unique IS-2 in Treatment of Patients with Bacterial Vaginosis. Indian Journal of Microbiology.52(3): 396-399, 2011. B. coagulans has been shown to be effective in treating hypercholesterolemia. R. Sudha et al. Effect of Supplementation of Bacillus Coagulans Unique IS-2(ATCC pat-11748) on Hypercholesterolemic Subjects: A Clinical Study. International Journal of Probiotics and Prebiotics, 6,(2):89-94, 2011. In some embodiments, the supplement comprises about 1 million CFU of B. coagulans. In some embodiments, the supplement comprises about 10 million CFU of B. coagulans. In some embodiments, the supplement comprises about 100 million CFU of B. coagulans. In some embodiments, the supplement comprises about I billion CFU of B. coagulans. In some embodiments, the supplement comprises about 2 billion CFU of B. coagulans. In some embodiments, the supplement comprises about 3 billion CFU of B. coagulans. In some embodiments, the supplement comprises about 4 billion CFU of B. coagulans. In some embodiments, the supplement comprises about 5 billion CFU of B. coagulans. In some embodiments, the supplement comprises about 6 billion CFU of B. coagulans. In some embodiments, the supplement comprises about 7 billion CFU of B. coagulans. In some embodiments, the supplement comprises about 8 billion CFU of B. coagulans. In some embodiments, the supplement comprises about 9 billion CFU of B. coagulans. In some embodiments, the supplement comprises about 10 billion CPU of B. coagulans.

Any type of premade or market ready raw kombucha can be used in the present methods. The premade or market ready kombucha can be flavored or unflavored. Flavoring may include berry, citrus, melon, herbal, apple, cherry, peach, pear, ginger, and combinations thereof, to list only a few possibilities. In some embodiments, the premade or market ready raw kombucha comprises a fruit flavoring having naturally occurring pectin and low water content. In some embodiments, the concentration of pectin present in the fruit flavoring is between about 0.1% to about 5% by weight. In some embodiments, the concentration of pectin present in the fruit flavoring is between about 0.25% to about 4.5% by weight. In some embodiments, the concentration of pectin present in the fruit flavoring is between about 0.5% to about 4% by weight. In some embodiments, the concentration of pectin present in the fruit flavoring is between about 0.75% to about 3.5% by weight. In some embodiments, the concentration of pectin present in the fruit flavoring is between about 1% to about 3% by weight.

The supplement can be in any dosage form. Some non-limiting examples of dosage forms can include topical, capsule, pill or tablet, gummy, soft chew, panned chew, sachet, gel, liquid, bulk powder for reconstitution or a drink prepared from bulk powder, to list only a few possibilities. In some aspects, the composition can be incorporated into a form of food and/or drink. Non-limiting examples of food and drinks where the composition is incorporated can include bars, shakes, juices, beverages, frozen food products, fermented food products, and cultured dairy products such as yogurt, yogurt drink, cheese, acidophilus drinks, and kefir. In some embodiments, the supplement is in the form of a gummy containing an active ingredient comprising the probiotic.

In some embodiments, the probiotic comprises an amount of greater than about 40% by weight. For example, the probiotic may be present in an amount of from about 40 to about 90% by weight, about 40 to about 80% by weight, about 40 to about 75% by weight, about 40 to about 70% by weight, about 45 to about 70% by weight, about 50 to about 70% by weight, or about 45 to about 65% by weight, or may be present in ranges of amounts within any of the foregoing ranges. In some embodiments, the probiotic comprises an amount of from about 40 to about 70% by weight. For example, the probiotic may be present in an amount of 43 to about 70% by weight. In yet other embodiments, the probiotic comprises an amount of 45 to about 70% by weight. In still other embodiments, the probiotic comprises an amount of 50 to about 70% by weight. In still other embodiments, the probiotic comprises an amount up to about 65% by weight, up to about 67% by weight, up to about 70% by weight, or up to about 75% by weight. Preferably, the probiotic comprises an amount from about 65 to about 95% by weight.

In some embodiments, the supplement disclosed herein may include a gelling agent. Exemplary gelling agents can include, but not limited to pectin, gelatin, seaweed extract, agar-agar, carrageenan, gum Arabic, and any combinations thereof. In some embodiments, pectin, a structural acidic heteropolysaccharide derived from fruits, may be used as a gelling agent. Pectin expands and gels, rendering it a suitable candidate for gelation of a gummy. In some embodiments, agar-agar, a polysaccharide obtained from the cell walls of red algae, may be used as a gelling agent. Some non-limiting concentrations of gelling agent in the supplement in weight percentages can include, but not limited to, about 0.1% to 60%, about 0.5% to 50%, about 1% to 40%, about 1.5% to 35%, about 1.75% to 30%, about 2% to 20%, or about 5% to 7%. In some embodiments, the concentration of the gelling agent can be about 1% to 20% by weight. In some embodiments, the concentration of the gelling agent can be about 1.5% to 10% by weight. In some embodiments, the concentration of the gelling agent can be about 1.75% to 7% by weight. In some embodiments, the concentration of the gelling agent can be about 8% to 20% by weight. In some embodiments, the concentration of the gelling agent can be about 1% to 50% by weight. In some embodiments, the concentration of the gelling agent can be about 2% to 30% by weight. In some embodiments, the concentration of the gelling agent can be about 3% to 20% by weight.

The supplement can be manufactured using the present method to be vegan or non-vegan. In some embodiments, the supplement is vegan and the gelling agents are preferably pectin and agar-agar.

The pectin can be certified organic or non-organic and can be derived from GMO and non-GMO sources. In some embodiments, the pectin is certified organic and derived from non-GMO sources. Innate pectin contained within the fruit flavoring of the raw probiotic may contribute to gelation and reduces the amount of additional pectin that may be added during gelation.

The agar-agar can be certified organic or non-organic and can be derived from GMO and non-GMO sources. In some embodiments, the agar-agar is certified organic and derived from non-GMO sources.

In some embodiments, agar-agar is preferably added at an amount of 1% by weight.

In some embodiments, the supplement disclosed herein can include a sweetener, which can be in solid or liquid form. In some embodiments, the sweetener can be a disaccharide. Exemplary sweeteners can include, but not limited to, non-organic cane sugar, organic cane sugar, sugar alcohol, natural sweeteners such as stevia, monk fruit, or blue weber agave syrup, sugar alternatives such as short length carbohydrate, any of the plethora of artificial sweeteners known to one of ordinary skill in the art, and any combinations thereof. In some embodiments, organic cane sugar can be used as a sweetener. Some non-limiting concentrations of sweetener in the nutritional supplement in weight percentages can include, but not limited to, about 10% to 80%, about 15% to 75%, about 20% to 70%, about 25% to 65%, about 30% to 60%, about 35% to 55%, or about 40% to 50%. In some embodiments, the concentration of the sweetener can be about 25% to 70% by weight. In some embodiments, the concentration of the sweetener can be about 35% to 60% by weight. In some embodiments, the concentration of the sweetener can be about 42% to 50% by weight.

In some embodiments, the sweetener is a sweetener having a low glycemic index so as to not contribute to raising blood sugar level upon consumption. In some embodiments, the low glycemic index sweetener is blue weber agave syrup, which has a glycemic index ranging from about 19-27. Other sweeteners such as honey and high fructose corn syrup have glycemic indices of 83 and 89 respectively. Sweeteners having a low glycemic index provides the advantages of sweetening and increasing the sugar content of the probiotic mixture following dissipation of concentrated sweetness via addition of the one or more gelling agents without dramatic increase of blood sugar level upon consumption of the supplement.

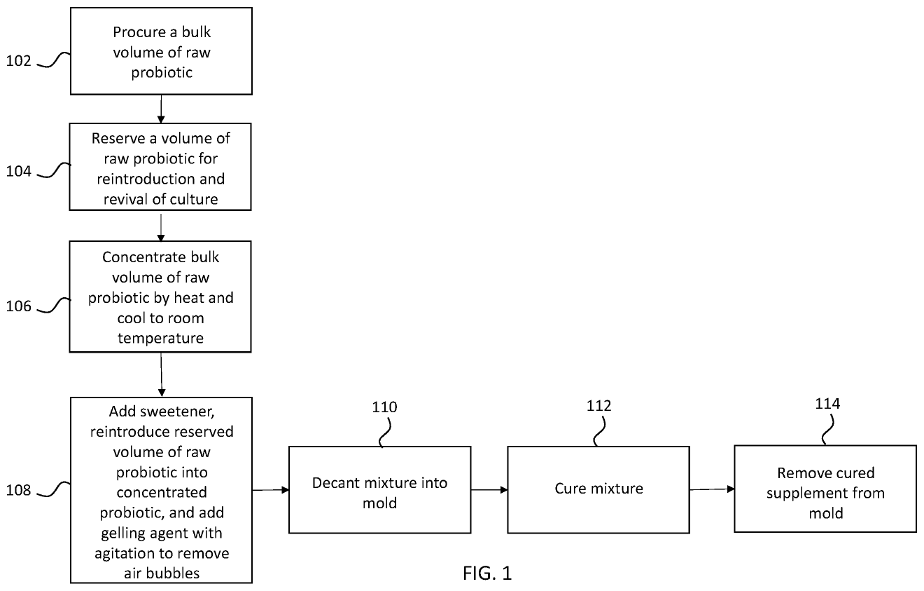

FIG. 1 is a flow diagram of one example of a method 100 of making a supplement in accordance with some embodiments. At block 102, a bulk volume of a raw probiotic, such as kombucha, may be obtained or procured.

At block 104, in some embodiments, a volume of the raw probiotic may be reserved for subsequent revival of the probiotic culture following concentration. For example, a volume of the raw probiotic may be removed from the bulk volume of raw probiotic put aside, and the reserved volume may be added in a subsequent step following concentration such that the probiotic culture can grow and thrive in the final supplement and extend the shelf life of the product. The reserved volume may depend on the desired final volume of the concentration, the relative scale of manufacture, and/or the relative level present in the raw probiotic. For example, on a small scale starting from 16 fluid ounces of raw probiotic in which the desired final volume following concentration is one quarter of the original volume (i.e. 4 fluid ounces), 1, 2, or 3 fluid ounces may be removed from the bulk volume of probiotic, which is reduced to a concentrated volume of 3, 2, or 1 fluid ounces respectively during concentration. In another example, on a larger scale manufacture starting from 16,000 fluid ounces of raw probiotic in which the desired final volume following concentration is one quarter of the original volume (i.e. 4000 fluid ounces), between 50 to 3950 fluid ounces may be removed from the bulk volume of probiotic, which is reduced to a concentrated volume of 3950 to 50 fluid ounces during concentration.

At block 106, the bulk volume of the raw probiotic may be concentrated. In some embodiments, the bulk volume is concentrated by heating the bulk volume to evaporate water from the raw probiotic, which reduces the volume. Any method for the evaporation of water via the application of heat known in the art may be used and the evaporation of water from the raw probiotic may be accomplished at any applicable pressure, including above and below atmospheric pressure. The remaining volume of the bulk volume may be cooled to room temperature after heating.

The bulk volume of raw probiotic can be reduced during the concentration step to any final volume necessary for manufacture. In some embodiments, the final volume is the sum of the volume of reserved raw probiotic and the concentrated volume following evaporation of water from the raw probiotic. The final volume can be, for example, three fourths, one half, one third, one quarter, one eighth, one twelfth, or one sixteenth of the original bulk volume of raw probiotic. In some examples, the final volume is one quarter of the original bulk volume of probiotic.

Concentration of the raw probiotic can occur at any temperature at which water evaporates. Concentration of the raw probiotic can occur between, for example, 60-212° F. In some methods, the concentration step occurs between 150-190° F. In yet other methods, the concentration step occurs between 160-170° F. The time needed to achieve completion of the concentration step will depend on the desired final volume and the temperature and pressure at which concentration is carried out.

At block 108, the concentrated volume of probiotic may be allowed to cool to a temperature at which the reserved volume of raw probiotic can be reintroduced such that cultures within the reserved raw probiotic can grow and thrive and essentially revive the probiotic culture because it is inevitable that the temperatures at which the concentration step is carried out will kill most of the probiotic culture. The reintroduction serves to revive the probiotic culture. The concentrated volume of probiotic can be allowed to cool to a temperature between 65 and 85° F., more particularly between 69 and 71° F. Depending on other atmospheric conditions, temperatures below this range may stifle and slow the growth of the probiotic culture and temperatures above this range can lead to subsequent denaturing and death of the probiotic culture. Cooling of the concentrated volume of probiotic can be accomplished by any means known in the art, which may include cooling under room temperature, refrigeration, cooling using an ice bath, and cooling through the use of a fan, to list only a few types of cooling. Following cooling, the reserved raw probiotic is reintroduced into the concentrated volume of probiotic to achieve the final volume of probiotic.

The final volume of probiotic undergoes gelation in which a gelling agent is introduced into the final volume of probiotic. Prior to addition of the gelling agent, the viscosity of probiotic is measured. Viscosity can be measured by any method known in the art. For example, viscosity can be measured using a capillary viscometer, a Zahn cup, a falling sphere viscometer, a vibrational viscometer, a rotational viscometer, a falling-piston viscometer, a bubble viscometer, a rectangular-slit viscometer, or a Krebs viscometer. The viscosity may be between about 10000 to about 40000 poise or 15000 to 35000 poise prior to gelation. In some examples, the viscosity of the probiotic is between about 20000 to about 30000 poise. The high viscosity permits the composition to further set and gel to achieve the desired texture and firmness of the final supplement. In some examples, the gelling agents are pectin and agar-agar.

The amount of gelling agent to be added depends on the sugar level of the final volume of probiotic and the desired sugar level of the final supplement. The sugar level can be measured by any suitable method. The sugar level may be measured using a refractometer in which the sugar level is represented in percent Brix. Following concentration and reintroduction of the reserved volume of raw probiotic, the sugar level of the final volume of probiotic can measure between 55 to 65% Brix as measured by refractometry. In some embodiments, to a trained expert palate, the final volume of probiotic has an excessively sweet and strong taste.

To dissipate and dilute the excessively sweet and strong taste of the final volume of probiotic, one or more gelling agents, such as additional pectin and agar-agar, may be added to the final volume of probiotic to lower the sugar level to about 5 to about 30% Brix as measured by refractometry. Addition of the one or more gelling agents causes expansion, which dissipates and dilutes the final volume of probiotic. To both increase the sugar level and to provide an environment for the probiotic culture to grow and thrive, a sweetener such as blue weber agave syrup, may be added. In some embodiments, the sugar level following addition of gelling agent and sweetener is from about 10 to about 25% Brix as measured by refractometry. In yet other embodiments, the sugar level following addition of gelling agent and sweetener is from about 15 to about 20% Brix as measured by refractometry.

The reintroduction of reserved probiotic and addition of sweetener and gelling agent can occur in any order or simultaneously. In some embodiments, the sweetener was added first, the reserved probiotic second, and the gelling agent last. In some embodiments, the sweetener was added first, the gelling agent second, and the reserved probiotic last. In some embodiments, the reserved probiotic was added first, the sweetener second, and the gelling agent last. In some embodiments, the reserved probiotic was added first, the gelling agent second, and the sweetener last. In some embodiments, the gelling agent was added first, the reserved probiotic second, and the sweetener last. In some embodiments, the gelling agent was added first, the sweetener second, and the reserved probiotic last. In some embodiments, the gelling agent, the reserved probiotic second, and the sweetener were added simultaneously in a single step.

During the addition of the one or more gelling agents, the viscosity of the mixture increases, leading to the formation of air bubbles and air pockets that can adversely affect the aesthetics and the internal structure of the final supplement. Removal of larger air bubbles that form can be accomplished by any methods known in the art. Air bubbles can be removed through agitation of the mixture, preferably through vibration of the mixture (i.e. shaking) such that the air bubbles come out of the top surface of the mixture. The mixture can be manually or mechanically shaken to force air bubbles to the surface of the mixture.

Agitating and mixing of the mixture containing the probiotic, the one or more gelling agents, and sweetener can occur at any applicable temperature. Agitation and mixing can occur between 40 to 110° F., 50 to 100° F., or 60 to 90° F. The agitation and mixing may occur between 65 and 85° F.

Additional flavoring agents or flavorants may be added and mixed into the mixture. The flavoring agents may be any natural or non-natural substance which adds or enhances flavor. The flavoring agents may also comprise natural or non-natural stabilizers, anti-caking and/or flow agents. Flavoring agents are typically comprised of a flavored substance(s) and complexes manufactured or extracted from nature in liquid or powdered form to impart a particular flavor into a product. Excipients are added to preserve, stabilize and maintain form and color. Typical excipients may include flow agents, anticaking agents, antioxidants, including but not exclusively, maltodextrin, gum acacia, tapioca starch, propylene glycol and triacetin. The flavoring agent or combination of flavoring agents may be present at a concentration of about 0.01 to about 20 wt %, more preferably about 0.05 to about 10 wt % or even more preferably about 0.1 to about 2 wt %.

In some embodiments, the flavoring agent may be employed in either liquid form (e.g., oil-based composition) and/or dried form. These flavorings may be chosen from synthetic flavor oils and flavoring aromatics and/or oils, oleoresins and extracts derived from plants, leaves, flowers, fruits, and so forth, and combinations thereof. Non-limiting representative flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassava oil. Also useful flavorings are artificial, natural and synthetic fruit flavors, such as vanilla, and citrus oils including lemon, orange, lime, grapefruit, yazu, sudachi, and fruit essences including apple, pear, peach, grape, blueberry, strawberry, raspberry, cherry, plum, pineapple, apricot, banana, melon, apricot, ume, cherry, raspberry, blackberry, tropical fruit, mango, mangosteen, pomegranate, papaya, and so forth. Other potential flavors whose release profiles may be managed include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. Commonly used flavors include mints, such as peppermint, menthol, spearmint, artificial vanilla, cinnamon derivatives, and various fruit flavors, whether employed individually or in admixture. In some embodiments, the flavoring agents are natural basil leaves.

The additional flavoring agents or flavorants may be introduced at any step depending on the oils, aromatics, or extracts to be released and whose activation for release of the flavoring depends on the condition of the additional flavoring agent or flavorant and environmental conditions such as temperature. In some embodiments, the additional flavoring agent or flavorant can be bruised, ground, grated, sliced, pulverized, or muddled prior to introduction. the additional flavoring agent or flavorant. In some embodiments the additional flavoring agents or flavorants are introduced during the heating of the concentration step. In some embodiments the additional flavoring agents or flavorants are introduced during the cooling of the concentration step. In some embodiments the additional flavoring agents or flavorants are introduced during the addition of sweetener, reserved probiotic, and gelling agent. In some embodiments the additional flavoring agents or flavorants are present in the mold in which the mixture is poured for curing. In some embodiments the additional flavoring agents or flavorants are introduced during the curing step. In some embodiments the additional flavoring agents or flavorants are introduced following removal of the cured supplement from the mold. In some embodiments, the additional flavoring agent or flavorant is removed prior to achieving the final supplement.

In some embodiments, following gelation, the mixture described herein may be sized into any suitable shape or size as desired depending on the final application and use. For example, the mixture may be sized by using common techniques such as molding, extruding, dicing, sheeting, slicing, or a combination of any two or more thereof. In some embodiments, the method described herein may include depositing or pouring the mixture into molds of a desired size and shape. In still other embodiments, the method described herein may include molding the mixture into a desired size and shape. In still yet other embodiments, the method described herein may include cooling the heated mixture and cutting or forming it into the desired size and shape.

At block 110, the mixture may be decanted or deposited into a mold for shaping and curing of the supplement. Any suitable molding technique can be used. For example, corn starch molds or silicone molds may be used. In some embodiments, the mixture is poured into a silicone mold for curing. The mold can be of any shape and can include geometric shapes such as a cylinder, sphere, cube, pyramid, and the like; and novelty shapes such as novelty characters, bears, stars, worms, and rings fruit, for example.

In some embodiments, the supplement can be in the shape of a substantially rounded cylinder, such as a dot form or rounded, truncated cone, or cylinder form. The individual pieces in that embodiment can have a diameter of from about 14 mm to 18 mm, about 12 mm to 20 mm, about 13 mm to 15 mm, or about 15 mm to 18 mm. The individual pieces in that embodiment can have a height of from about 14 mm to 22 mm, about 15 mm to 20 mm, about 16 mm to 18 mm, or about 17 mm to 22 mm. In some embodiments, the weight of an individual piece can be from about 1 gram to 10 grams, about 1 gram to 8 grams, about 1 gram to 6 grams, about 1 gram to 4 grams, about 2 grams to 4 grams, about 2.2 grams to 2.8 grams, about 2.5 grams to 3.5 grams, or about 3 grams to 4 grams. In some embodiments, the weight of an individual piece can be about 4 grams.

At block 112, the molded mixture may be cured. Preferably, curing is accomplished in a dehydrator. The time required for curing will depend on the temperature and pressure of the curing process. The curing temperature for the present supplement can range from about 60 to about 80° F., preferably from about 65 to about 75° F., even more preferably from about 68 to about 72° F. However, it should be understood that other curing techniques may be used.

In some embodiments, the curing is conducted at about 0% to about 50% relative humidity. In other embodiments, the relative humidity for curing is from about 0% to about 40%, about 10% to about 30%, or about 20% to about 25%. In some embodiments, the relative humidity for curing is from about 10% to about 30%.

The curing equipment and conditions may be selected so as to obtain a specific moisture or water content in the end product. In some embodiments, the method described herein includes curing the composition to a water content of about 5 wt % to about 40 wt %, about 10 wt % to about 30 wt %, or about 15 wt % to about 20 wt % of the total weight of the composition. In further embodiments, the method described herein includes curing the composition to a water content of about 16 wt % to about 20 wt % of the total weight of the composition.

The disclosed methods provide a supplement comprising a living probiotic culture, which contributes to extending the shelf life of the product. The probiotic culture lives and thrives on the sugar content introduced by the sweetener. This provides a supplement having a living probiotic culture that can survive storage (shelf life) from about 12 days to about 2 years; from about 1 month to about 18 months; from about 3 months to about 1 year; or from about 6 months to about 9 months. from the date of manufacture.

At block 114, the cured supplement may be removed from the mold.

The present disclosure will be further illustrated in the following Examples which are given for illustration purposes only and are not intended to limit the disclosure in any way.

### EXAMPLES

### Example 1

### Manufacture of Kombucha Supplement

The following Example describes the steps used in the manufacture of the present supplement.

A 16 fluid ounce bottle of KeVita Master Brew Kombucha® in blueberry basil flavor was used in the present method. One fluid ounce of the kombucha was removed from the bottle and reserved for the reintroduction of the live probiotic culture following concentration of the remaining kombucha.

The remaining 15 fluid ounces of the blueberry basil KeVita Master Brew Kombucha® were poured into a 4-quart saucepan and heated to a controlled temperature of 165° F. for one hour during which time the volume of the kombucha gradually decreased as a result of water evaporating from the kombucha. After the volume of kombucha was reduced down to approximately 3 fluid ounces, the kombucha was removed from the heat and allowed to come to room temperature, about 68° F. During the cooling of the kombucha, 5 g of basil leaves were bruised using a mortar and pestle and added to the concentrated kombucha. When the concentrated kombucha reached 68° F., the bruised basil leaves were removed from the concentrated kombucha.

The final volume of kombucha had an excessively sweet and strong taste according to a trained expert palate due to the concentration of the kombucha' s sugar content following the concentration step. The viscosity of the resulting kombucha was measured prior to the addition of the sweetener, the reserved probiotic, and the gelling agent. The viscosity measured between 20000 to 30000 poise as measured by capillary viscometry.

In this Example, the sweetener was added to the cooled kombucha first, followed by addition of the reserved probiotic, and addition of the gelling agent occurred last prior to molding the mixture.

The sugar content of the concentrated kombucha measured approximately 60% Brix as measured using a refractometer. The addition of gelling agent dissipates and dilutes the intense flavors obtained from the concentration step because the gelling agent causes expansion. To provide additional sweetness and to create the sugary environment in which the probiotic culture can thrive, a sweetener is added to the concentrated probiotic. In particular, blue weber agave syrup was added to achieve a sugar level of approximately 20% Brix at which point a balance between the sweetness and intensity of the flavoring was achieved.

Following addition of the sweetener, the 1 fluid ounce of reserved raw kombucha was added back into the obtained concentrated volume of kombucha such that the final volume of kombucha is 4 fluid ounces. The probiotic cultures of the reserved raw kombucha are still alive and serve to revive the cultures killed during the concentration step.

The balance between sweetness and intensity may be monitored by a trained expert palate, as variations in the conditions used to cultivate and grow the probiotic culture of the kombucha may vary depending on the manufacturer. In other words, each probiotic culture is produced in its own “terroir” that may impart variations in taste and intensity despite strict adherence to any set of steps or procedures to cultivate and grow the probiotic culture.

1% by weight of agar-agar as the gelling agent was added following reintroduction of the reserved kombucha.

The mixture containing the concentrated kombucha, agar-agar, and was placed on a shaker and agitated by hand to mix the contents until air bubbles were no longer observed to be present within the mixture and when air bubbles no longer came out of the top surface of the mixture.

Following mixing and agitation, the mixture was decanted into 1″×1″ silicone ice cube trays for molding and curing of the supplement. The ice cube trays containing the mixture were placed in a dehydrator at a controlled temperature of 70° F. at atmospheric pressure and between 33-35% relative humidity for two weeks to achieve the curing and aging of the supplement.

After curing for two weeks, the cured supplement was removed from the silicone tray.

### Example 2

### Demonstration of Live Cultures in Supplement

To demonstrate that the probiotic cultures were alive and remained viable following manufacture of the supplement, the supplement from Example 1 was added to a solution of water and sugar.

Following addition of the supplement from Example 1 to the solution of water and sugar, the observation of the formation of bubbles, a mucus-like head that formed at the top of the liquid, and the evolution a yeasty ferment odor was indicative that the cultures contained within the final supplement were living.

Having thus described in detail preferred embodiments, it is to be understood that the supplements and method of making them described above are not to be limited to particular details set forth in the above description as many apparent variations thereof are possible without departing from the spirit or scope of the present invention.

What is claimed is:

1. A method of making a supplement, comprising the steps of:
procuring a bulk volume of a probiotic, wherein the probiotic optionally comprises a flavor;
reserving a volume of the probiotic;
concentrating the remaining bulk volume of probiotic to obtain a concentrated volume of probiotic;
optionally introducing one or more flavoring agents;
reintroducing the reserved volume of probiotic to obtain a final volume of probiotic;
adding a sweetener and one or more gelling agents to the final volume of probiotic to form a mixture, wherein the sweetener creates a sugary environment;
agitating the mixture to remove air bubbles;
pouring the mixture into a mold; and
curing the mixture to obtain the supplement;
wherein the probiotic grows and thrives on the sugary environment and the probiotic remains viable following curing of the supplement.

2. The method of claim 1, wherein the probiotic comprises kombucha.

3. The method of claim 1, wherein the supplement comprises the probiotic at a concentration between about 65 to about 95% by weight.

4. The method of claim 1, wherein the final volume of probiotic is between one half to one eighth of the bulk volume of probiotic.

5. The method of claim 4, wherein the final volume of probiotic is one quarter of the bulk volume of probiotic.

6. The method of claim 1, wherein the concentrating step comprises heating the remaining bulk volume of probiotic between 150 to 190° F.

7. The method of claim 1, wherein the final volume of probiotic comprises a sugar level between about 55 to about 65% Brix.

8. The method of claim 1, wherein the sugar level following the adding step is between about 10 to about 25% Brix.

9. The method of claim 1, wherein the concentrating step comprises killing probiotic cultures.

10. The method of claim 9, wherein the reintroducing step revivifies the probiotic cultures.

11. The method of claim 1, wherein the reintroducing step occurs between about 65 to 85° F.

12. The method of claim 1, wherein the one or more gelling agents comprises agar-agar.

13. The method of claim 1, wherein the flavor of the probiotic is a fruit comprising between 0.1% to about 5% by weight of pectin.

14. The method of claim 13, wherein the one or more gelling agent comprises the pectin of the fruit and agar-agar.

15. The method of claim 1, comprising about 1% by weight of agar-agar.

16. The method of claim 1, comprising between about 10 to about 30% by weight of sweetener.

17. The method of claim 1, wherein the sweetener is blue weber agave syrup.

18. The method of claim 1, wherein the probiotic remains viable for at least 3 months from manufacture.

19. The method of claim 18, wherein the probiotic remains viable for up to one year from manufacture.

20. A supplement comprising a living probiotic culture and a sugary environment for the living probiotic culture to grow and thrive made by the method of claim 1.
